(19) United States
(12) Patent Application Publication
(10) Pub. No.: US 2015/0045029 A1
(43) Pub. Date: Feb. 12, 2015

(54) Method and Apparatus Providing Data Offloading and Carrier Aggregation Associated Measurement Reporting

(71) Applicants: Lars Dalsgaard, Oulu (FI); Jussi-Pekka Koskinen, Oulu (FI); Jarkko Koskela, Oulu (FI); Ilkka Keskitalo, Oulu (FI); Esa Malkamaki, Espoo (FI)

(72) Inventors: Lars Dalsgaard, Oulu (FI); Jussi-Pekka Koskinen, Oulu (FI); Jarkko Koskela, Oulu (FI); Ilkka Keskitalo, Oulu (FI); Esa Malkamaki, Espoo (FI)

(73) Assignee: Nokia Corporation, Espoo (FI)

(21) Appl. No.: 14/383,248

(22) PCT Filed: Mar. 19, 2012
(86) PCT No.: PCT/IB2012/051315

§ 371 Date: Oct. 7, 2014

(51) Int. Cl. H04W 36/00; H04W 36/22

(52) U.S. Cl. CPC H04W 36/0083; H04W 36/22
USPC 455/436

(57) ABSTRACT

An exemplary method includes operating a user equipment in a macro cell and selectively, based on at least one criterion, at least one of measuring or not measuring a small cell located within the macro cell, and transmitting or not transmitting a measurement report for the small cell to a wireless network. The use of embodiments of this invention enables intelligent decisions to be made in a heterogeneous network (HetNet) at least with respect to the use of small cells for data offloading purposes. Another exemplary method includes operating a user equipment with at least one component carrier and, responsive to at least one criterion, selectively at least one of performing measuring or not performing measuring of a component carrier other than a component carrier with which the user equipment is currently operating, and transmitting or not transmitting a measurement report for a measured component carrier to a wireless network.

### TECHNICAL FIELD

The exemplary and non-limiting embodiments of this invention relate generally to wireless communication systems, methods, devices and computer programs and, more specifically, relate to heterogeneous network (HetNet) deployments, data offloading, small cells, mobility, user equipment (UE) measurements and reporting, UE idle and connected modes and to enhanced diverse data application (EDDA) operation.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

In current 3GPP study items related to HetNet mobility it has become apparent that future networks will require a number of small cells (small relative to a macro cell in which the small cells may be located) to be deployed in order to cope with the expected increase in demand for higher data rates and faster connections. To achieve a workable solution the small cells need to be detected by the UE and reported to the network in order to gain the benefits that can be realized from the deployment of the small cells.

### SUMMARY

In a first aspect thereof the exemplary embodiments of this invention provide a method that comprises operating a user equipment in a macro cell and selectively, based on at least one criterion, at least one of measuring or not measuring a small cell located within the macro cell, and transmitting or not transmitting a measurement report for the small cell to a wireless network.

In a further aspect thereof the exemplary embodiments of this invention provide an apparatus that comprises at least one data processor and at least one memory that includes computer program code. The at least one memory and computer program code are configured, with the at least one data processor, to cause the apparatus, when a user equipment is operated in a macro cell of a wireless network, to selectively, based on at least one criterion, at least one of measure or not measure a small cell located within the macro cell, and transmit or not transmit a measurement report for the small cell to the wireless network.

In another aspect thereof the exemplary embodiments of this invention provide a method that comprises determining at a wireless network a current operational state of a user equipment that is located within a macro cell of the wireless network, where the macro cell contains at least one small cell; and based at least on the determined current operational state of the user equipment, making at least one of a small cell measurement decision, a small cell measurement reporting decision, and a small cell handover decision for the user equipment.

In yet another aspect thereof the exemplary embodiments of this invention provide an apparatus that comprises at least one data processor and at least one memory that includes computer program code. The at least one memory and computer program code are configured, with the at least one data processor, to cause the apparatus to determine at a wireless network a current operational state of a user equipment that is located within a macro cell of the wireless network, where the macro cell contains at least one small cell and, based at least on the determined current operational state of the user equipment, to make at least one of a small cell measurement decision, a small cell measurement reporting decision, and a small cell handover decision for the user equipment.

In yet another aspect thereof the exemplary embodiments of this invention provide a method that comprises operating a user equipment with at least one component carrier and, based on at least one criterion, selectively at least one of performing measuring or not performing measuring of a component carrier other than a component carrier with which the user equipment is currently operating, and transmitting or not transmitting a measurement report for a measured component carrier to a wireless network.

In yet one further aspect thereof the exemplary embodiments of this invention provide an apparatus that comprises at least one data processor and at least one memory including computer program code. The at least one memory and computer program code are configured, with the at least one data processor, to cause the apparatus to operate a user equipment with at least one component carrier and, based on at least one criterion, selectively at least one of perform measuring or not perform measuring of a component carrier other than a component carrier with which the user equipment is currently operating, and transmit or not transmit a measurement report for a measured component carrier to a wireless network.

In still another aspect thereof the exemplary embodiments of this invention provide an apparatus that comprises means for operating a user equipment in a macro cell; and means for selectively, based on at least one criterion, at least one of measuring or not measuring a small cell located within the macro cell, and transmitting or not transmitting a measurement report for the small cell to a wireless network.

In one further aspect thereof the exemplary embodiments of this invention provide an apparatus that comprises means for determining at a wireless network a current operational state of a user equipment that is located within a macro cell of the wireless network, where the macro cell contains at least one small cell; and means, responsive to at least on the determined current operational state of the user equipment, for making at least one of a small cell measurement decision, a small cell measurement reporting decision, and a small cell handover decision for the user equipment.

In yet one further aspect thereof the exemplary embodiments of this invention provide an apparatus that comprises means for operating a user equipment with at least one component carrier; and means, responsive to at least one criterion, selectively at least one of performing measuring or not performing measuring of a component carrier other than a component carrier with which the user equipment is currently operating, and transmitting or not transmitting a measurement report for a measured component carrier to a wireless network.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 shows a non-limiting example of a basic use case of the embodiments of this invention.

FIG. 3 is a logic flow diagram that illustrates the operation of a method, and a result of execution of computer program instructions embodied on a computer readable medium, in accordance with the exemplary embodiments of this invention.

FIG. 4 is a logic flow diagram that illustrates the operation of a method, and a result of execution of computer program instructions embodied on a computer readable medium, further in accordance with the exemplary embodiments of this invention.

FIG. 5 shows a non-limiting example of carrier aggregation with five overlapping component carriers, each with an LTE Rel-8 bandwidth of 20 MHz.

FIG. 6 is a logic flow diagram that illustrates the operation of a method, and a result of execution of computer program instructions embodied on a computer readable medium, further in accordance with the exemplary embodiments of this invention.

### DETAILED DESCRIPTION

Of interest herein may be 3GPP TS 36.304 V10.4.0 (2011-12) Technical Specification 3rd Generation Partnership Project; Technical Specification Group Radio Access Network; Evolved Universal Terrestrial Radio Access (E-UTRA); User Equipment (UE) procedures in idle mode (Release 10), e.g., Section 5, “Process and procedure descriptions”, as well as 3GPP TS 36.331 V10.4.0 (2011-12) Technical Specification 3rd Generation Partnership Project; Technical Specification Group Radio Access Network; Evolved Universal Terrestrial Radio Access (E-UTRA); Radio Resource Control (RRC); Protocol specification (Release 10), e.g., Section 5, “Procedures”, and more specifically Section 5.5, “Measurements”.

As employed herein “data offloading” may be assumed to mean that some data to be transmitted from or received by a user equipment is actually conveyed through a cell other than a currently serving macro cell of the user equipment. Data offloading may thus be viewed as a technique to, e.g., conserve bandwidth of the macro cell (e.g., an E-UTRAN macro cell), increase user experience through increased data throughput, and lower UE power consumption and efficient use of network resources.

Reference may be made to 3GPP TSG-RAN WG2 Meeting #77, R2-120107, Dresden, Germany, 6-10 Feb. 2012, Agenda item: 7.10.5, Source: Nokia Corporation, Nokia Siemens Networks, Title: Discussion of HetNet Mobility. In this document the fundamental problems of HetNet deployment and mobility are outlined. As is stated in this document in the connected mode the effects of suboptimal mobility can be severe and the mobility functionality in HetNet scenarios should at least try to assess the goals of the various study item (SI) scenarios:

(a) Seamless and robust mobility of users from the LTE macro cell to the small base transceiver station (BTS) layer, and vice versa, shall be supported to enable offload benefits.
(b) In order to enable offloading and robust mobility there is a need to have efficient discovery of small cells combined with equally efficient and robust mobility procedures. Offloading is not possible if the NW cannot handover a UE to available small cells, i.e., it needs to be ensured that reasonable offloading possibilities and tools are available for the operator/network.

For HetNet mobility some specific types of problems may be more apparent than in homogeneous network scenarios. With respect to the HetNet SI, reference may be made to 3GPP TSG-RAN Meeting #52, RP-110709, Bratislava, Slovakia, May 31-Jun. 3, 2011, Source: Alcatel-Lucent (rapporteur), Title: Revised WID on Study on for Hetnet Mobility Enhancements for LTE. It is stated that in earlier contributions there have been an analysis of the potential challenges and a number of mobility problems have been outlined that need to be addressed and solved. These include an increased number of RRC Connection re-establishments as described in 3GPP TSG-RAN WG2 Meeting #77 R2-120525 Dresden, Germany, 6-10 Feb. 2012 Agenda item: 7.10.5 Source: Nokia Corporation, Nokia Siemens Network, Title: Re-establishment issues in HetNet scenarios. These problems and issues also include a possible increase in UE power consumption if the HetNet scenarios would require the use of very short discontinuous reception (DRX) periods (see 3GPP TSG-RAN WG2 Meeting #75bis, R2-115731 Zhuhai, China, 10-14 Oct. 2011, Agenda Item: 7.9.4, Source: Nokia Corporation, Nokia Siemens Network, Title: HetNet mobility and DRX). These problems and issues further include the presence of high-mobility users on a small BTS layer. Generally it does not seem to be a viable assumption to always assume that in HetNet scenarios all of the UEs are slow moving. Even in cities there are UEs within cars/busses/trains which in fact are quite fast moving, and one needs to ensure that such mobile UEs do not degrade the HetNet system performance unnecessarily. For example, mobility state estimation (MSE) may give incorrect estimates and may actually make the mobility situation worse (see 3GPP TSG-RAN WG2 Meeting #77, R2-120524, Dresden, Germany, 6-10 Feb. 2012, Agenda item: 7.10.4, Source: Nokia Siemens Networks, Nokia Corporation, Title: UE MSE and HetNet Mobility).

There is also an increased probability of radio link failure (RLF) and handover (HO) failure when fast moving users are served by small BTSs (see 3GPP TSG-RAN WG2 Meeting #75bis R2-115420, Zhuhai, China, 10-14 Oct. 2011, Agenda item:7.9, Source: Nokia Siemens Networks, Nokia Corporation, Title: Mobility robustness for fast moving UEs in HetNet). The discovery of small cells may introduce certain challenges, e.g., small cell discovery may take too long a time to allow efficient off loading, or the UE power consumption may become a problematic (see 3GPP TSG-RAN WG2 Meeting #77, R2-120523, Dresden, Germany, 6-10 Feb. 2012, Agenda item: 7.10.3, Source: Nokia Siemens Networks, Nokia Corporation, Title: Enhancements for Small Cell Detection).

After cell detection one needs to consider the measurements made and how quickly the UE is able to provide appropriate measurement results for offloading purposes. In addition, and as was noted above, the UE power consumption for finding small cells can be an issue. The document R2-120523 provides an analysis that considers in more detail the power consumption impact of finding small cells vs. offloading loss.

After the measurements have been performed they need to be reported to the eNB to enable their use, and one area of study is to determine if the sending of measurement results causes any critical delays. In general it may be important to consider if the use of different cell sizes can be problematic for robust mobility performance.

Further, after the reception of the measurement results at the eNB one needs to consider if there are any problems related to the delivery of the HO command and the execution of the HO preparations.

Generally one could say that it is beneficial to keep fast moving UEs out of small cells (HetNet mobility, DRX and MSE). It is on the other hand beneficial to use small cells for slow moving UEs, e.g., for offloading purposes or other network-related issues. This can be done in various ways, e.g., allowing slower cell detection to occur would ensure that a fast moving UE would not manage to report the presence of a small cell in time, but this could add delays for the slow moving UE. When the UE is in the small cell it is also important to ensure outbound robust mobility (see 3GPP TSG-RAN WG2 Meeting #77, R2-120108, Dresden, Germany, 6-10 Feb. 2012, Agenda item: 7.10.5, Source: Nokia Corporation, Nokia Siemens Networks, Title: HetNet mobility and DRX) while it is beneficial, e.g., for small cells to allow for good UE power savings when these are deployed in for example, a home or office environment with no or slow mobility. In order to allow good power saving options for the UE in the RRC Connected mode for ensuring superior user experience it is likely that there will be some trade-off between UE activity, UE power consumption and robust mobility which may make it an advantage to improve the handover errors in the form of improved call re-establishment (see the above-referenced R2-120525).

Based on what was said above in relation to R2-120107 it should be clear that there exists a need to address and solve a number of problems related to small cell operation in a HetNet. What is needed is a method for both the Idle mode and the Connected mode in E-UTRAN (as one non-limiting example) where the UE would perform the necessary measurements as defined by the network in such a way that the network would also have knowledge as to whether there is some UL data transmissions ongoing or soon to occur.

Currently defined approaches for measurement configuration, evaluation and reporting are basically that when an event has been triggered the UE will report the event to the network.

In the foregoing standard documents 3GPP TS 36.304 and 3GPP TS 36.331 the UE is configured with a measurement configuration that establishes rules for what the UE shall measure, rules concerning given events (which events, the rules for when an event is fulfilled, etc.) and rules for measurement reporting or cell reselection. Currently all measurements and events are by default considered as being needed, and a measurement report is always sent when an event has fulfilled the conditions established for measurement reporting.

In a HetNet environment there may be a network deployment where a macro cell layer is used mainly for UE basic connectivity and mobility purposes, while a small cell layer is used primarily for data offloading (when possible).

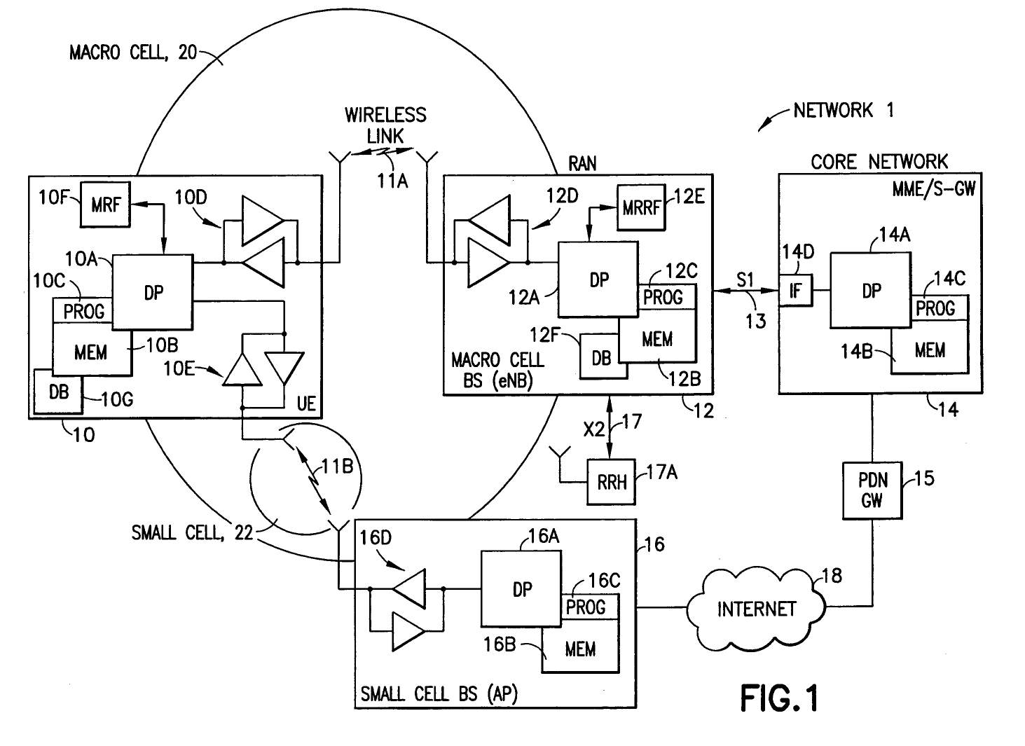

Before describing in further detail the embodiments of this invention reference is made to FIG. 1 for illustrating a simplified block diagram of various electronic devices and apparatus that are suitable for use in practicing various examples of the embodiments of this invention. FIG. 1 is assumed to represent at least one non-limiting example embodiment of a HetNet environment.

In FIG. 1 a wireless network (NW) 1 is adapted for communication over a first wireless link 11A with an apparatus, such as a mobile communication device which may be referred to as a UE 10, via a network access node, such as a Node B (base station), and more specifically an eNB 12 (in the non-limiting case of an E-UTRAN (evolved universal terrestrial radio access network) or LTE (long term evolution) deployment). The wireless network 1 can thus be implemented as a cellular wireless network, and in some embodiments can be compliant with LTE/LTE-A (LTE Advanced). The network 1 includes a core network that can include MME/S-GW (mobility management entity/serving gateway) 14 functionality, and that provides connectivity with a further network such as a telephone network and/or a data communications network (e.g., the Internet 18). In this embodiment the eNB 12 may be assumed to establish at least one macro cell 20. Other eNBs (not shown) also establish macro cells that may at least partially overlap the coverage area of the macro cell 20.

The UE 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) radio transmitter and receiver pair (transceiver) 10D for bidirectional wireless communications with the eNB 12 via one or more antennas and the wireless link 11A.

FIG. 1 also shows a “small cell” 22 that includes at least one small cell base station (BS) or BTS or access point (AP) 16. The small cell 22 could be a pico cell or a femto cell, as two non-limiting embodiments. The AP 16 may provide access to the Internet 18 and, via the Internet 18 and possibly also a packet data network (PDN) gateway (GW) 15, access to the MME/SGW 14. In some embodiments the UE 10 may have at least one further radio transmitter and receiver pair (transceiver) 10E for bidirectional wireless communications with the AP 16 via one or more antennas and a second wireless link 11B. In some non-limiting embodiments the second transceiver 10E may be compatible with a Wi-Fi transport radio. In some non-limiting embodiments the second transceiver 10E may be compatible with un-licensed spectrum such as ISM (industrial, scientific, medical) spectrum. Note that the second transceiver 10E may be compatible with a local area evolved 3GPP standard, or a transceiver separate from the transceiver 10E can be provided for this purpose.

It is pointed out that in some embodiments the small cell 22 can be established instead by a separate LTE compatible transceiver, such as a remote radio head (RRH) 17A that is connected with the eNB 12 via an X2 interface 17 and/or a dedicated low latency, high speed interface, such as one that uses optical fiber.

In some embodiments there can be two or more of the small cells 22, of the same or different type, that exist within the coverage area of the macro cell 20.

The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas (typically several when multiple input/multiple output (MIMO) operation is in use). The eNB 12 is coupled via a data/control path 13 to the MME/S-GW 14. The path 13 may be implemented as an S1 interface. The eNB 12 may also be coupled to another eNB (and/or to the RRH 17A) via the data/control path 17, which may be implemented as the X2 interface. Note that in some embodiments there could be an X2 interface 17 between the eNB 12 and the small cell BS, BSS or AP 16.

The eNB 12 as well as the AP 16 may separately or jointly be referred to as a Home Evolved NodeB (HeNB), or an office access point, a wireless node, a hotspot, or by any similar names and designators, as examples.

The MME/S-GW 14 includes a controller, such as at least one computer or a data processor (DP) 14A, at least one non-transitory computer-readable memory medium embodied as a memory (MEM) 14B that stores a program of computer instructions (PROG) 14C, and at least one suitable interface (IF) 14D, such as one compliant with the S1 interface 13, for conducting bidirectional communications with the eNB 12. The MME/S-GW 14 may be connected to the Internet 18 via the PDN gateway 15. The implementation of the S-GW separate from, or integrated into, the PDN gateway 15 is a design choice.

The AP 16 also includes a controller, such as at least one computer or a data processor (DP) 16A, at least one computer-readable memory medium embodied as a memory (MEM) 16B that stores a program of computer instructions (PROG) 16C, and at least one suitable RF transceiver 16D for communication with the UE 10 via one or more antennas.

For the purposes of describing the exemplary embodiments of this invention the UE 10 may be assumed to also include a measurement and reporting function (MRF) 10F, and the eNB 12 includes a measurement report receiver function (MRRF) 12E. At least one task of the MRF 10F and the MRRF 12E is to cause the UE 10 to measure and report via UL (uplink) signaling information related to signals received from other eNBs and/or other small cell base stations 16. The UE 10 can also include at least one uplink (UL) data buffer (DB) 10G for temporary storage of UL data prior to transmission. The state of the UL data buffer 10G can be made known to the eNB 12 via buffer status reports (BSRs) transmitted by the UE 10, or by other information included by the UE 10 in a measurement report (as discussed below). The eNB 12 (or some other NW entity) can also include at least one downlink (DL) data buffer (DB) 12F for temporary storage of DL data prior to transmission to the UE 10.

At least the PROGs 10C and 12C are assumed to include program instructions that, when executed by the associated data processor 10A and 12A, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware). The MRF 10F and the MRRF 12E can be assumed to be implemented at least in part by computer software executable by the DP 10A of the UE 10 and by the DP 12A of the eNB 12, respectively.

The various data processors, memories, programs, transceivers and interfaces depicted in FIG. 1 may all be considered to represent means for performing operations and functions that implement the several non-limiting aspects and embodiments of this invention.

In general, the various embodiments of the UE 10 can include, but are not limited to, cellular mobile devices, smartphones, communicators, tablets having wireless communication capabilities, laptop computers having wireless communication capabilities, tablet devices having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B, 12B, 14B and 16B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A, 12A, 14A and 16A may be of any type suitable to the local technical environment, and may include one or more of general purpose computers, special purpose computers, microprocessors, digital signal processors (DSPs) and processors based on multi-core processor architectures, as non-limiting examples.

For convenience, in the following description the (RF) radio transmitter and receiver pair (transceiver) 10D may be referred to, without a loss of generality, as the LTE radio 10D or as the LTE transport radio 10D or as the macro cell radio 10D, and the radio transmitter and receiver pair (transceiver) 10E (if present) may be referred to as the small cell radio 10E. These radios are assumed to include all necessary radio functionality, beyond just the transmitter and receiver per se, such as modulators, demodulators and baseband circuitry as applicable. Also, the reference to an LIE radio implies either LTE (LTE Rel-8) or LTE-A (e.g., Rel-9, or Rel-10, or Rel-11, higher). Note that by definition an LTE Advanced (LTE-A) compliant radio device may be assumed to be backward-compatible with LTE.

It is pointed out that a particular instance of the UE 10 could have multiple macro cell radios of the same or different types (e.g., a UTRAN transport radio and an E-UTRAN transport radio), and may also have multiple small cell radios 10E of the same or different type. Note also that in some embodiment the UE 10 may have a single radio 10D that is configurable for operation in both the macro cell 20 and the small cell 22.

The examples of the embodiments of this invention provide methods and apparatus to optimize the measurement reporting. In one aspect a method and apparatus make it possible to define a measurement configuration for the UE 10 such the measurements and reporting rules and events can be distinguished based on whether the measurement, measurement event and/or measurement report is for UE 10 mobility purposes, or for data offloading purposes.

The measurement configuration enables the UE 10 and/or the eNB 12 to distinguish measurement reporting events that are defined and triggered for mobility purposes (and having a high priority such that they should be sent to the eNB 12 when triggered) from measurement reporting events for the purposes of enabling data offloading. In this latter case the measurement reporting events may be distinguished by only being needed when there is a need for data offloading.

There are various non-limiting examples of embodiments to achieve these goals.

For example, in a first embodiment some specific measurement reporting events are configured for data offloading purposes, and the measurement report is not always sent unless a given set of additional conditions (potentially in addition to conventional radio conditions) are fulfilled. In addition to the normal radio-type of rules an event may have different types of conditions:

(a) the UE 10 has some type of ongoing downlink/uplink traffic;

(b) the UE 10 is not in background mode, i.e., the user is actively using the UE 10 or one or more of its application(s);

(c) an inter-arrival rate of packets and number of packets;

(d) the UE 10 has buffered for transmission (e.g., in the UL data buffer 10G) optionally the buffered data is more than some threshold amount of data;

(e) L1/L2/L3 (layer 1 (Physical layer), layer 2 (MAC layer), layer 3 (RRC layer)) user data buffers are not empty; and/or

(f) user data over a data radio bearer (DRB) has been received/transmitted in the recent past, e.g., user data was received/transmitted in the last x seconds/minutes.

One example that applies to the example (c) above, i.e., the inter-arrival rate of packets and number of packets, is as follows: the UE 10 has within recent history experienced active data transmission, i.e., frequent data exchange between the UE 10 and the eNB 12. ‘Frequent’ in this context may be defined as the inter-arrival time of bursts of packets and/or numbers of packets, etc.

In a second exemplary embodiment of this invention the UE 10 may add to (supplement) the measurement report with some information about or related to data, e.g., any one or more of the items (a)-(f) discussed above.

Further by example, in another embodiment the network (NW) may consider UE 10 buffer status reports (BSRs for UL data) and/or network buffers (e.g., DL data buffer 12F) in the decision process for performing HO based on measurement reports. For example, the network may not HO the UE 10 to a pico/small cell 22 if there is no data in the buffers (e.g., in the UE data buffer 10G) when the report is sent. This method may not be visible to the UE 10 at all as the network may combine in various ways the information that it has with existing reporting mechanisms.

Further by example, in a fourth exemplary embodiment if the UE 10 has knowledge of the background traffic mode then this information can be used to filter out the offloading events. The use of such information may be either specified or it may be controlled and/or enabled by the NW 1.

One non-limiting example of background traffic mode may be a UE 10 with an active application (such as a social networking application) which generates, for example, infrequent update/status traffic, even though the user is not actively using the UE 10.

Filtering out events, or possibly additional measurement reporting due to triggered events may, for example, be that measurement report sending is not performed by the UE 10 if there is no data buffered for transmission in the UE 10 or if there is buffered data but less than some threshold amount. As one non-limiting example, in the UE 10 assume that a measurement report event has been triggered towards an offload cell (e.g., towards a small cell) but because the UE 10 has no buffered data the report is filtered out, i.e., is cancelled.

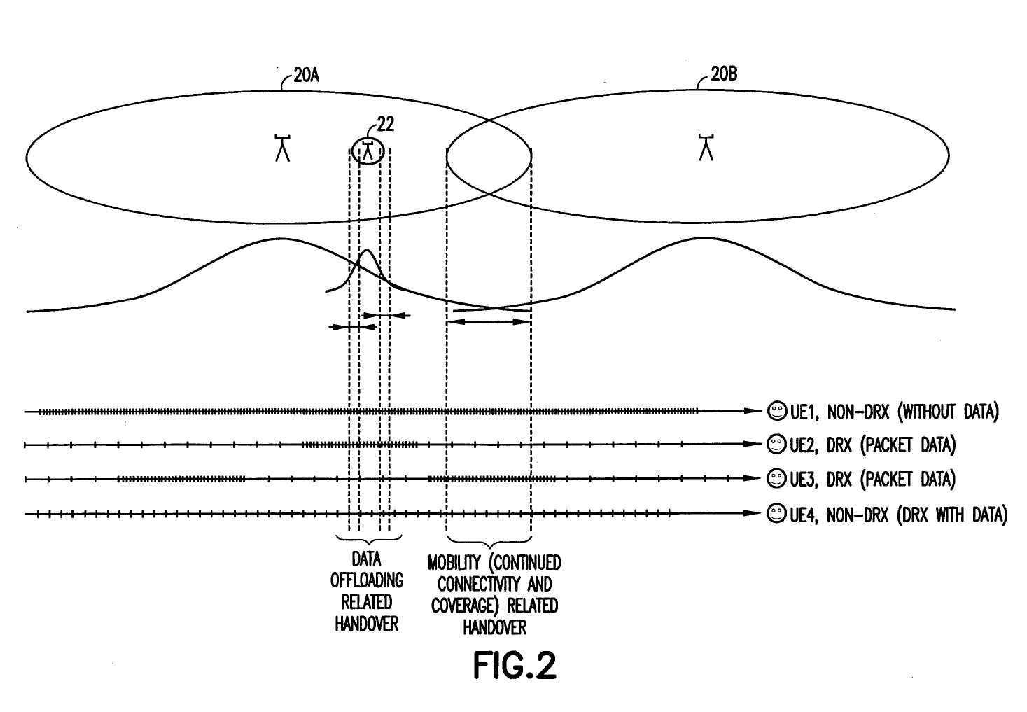

Reference can be made to FIG. 2 for illustrating simplified HetNet deployment scenario that includes just two macro cells 20 (20A and 20B) and one small cell 22 contained with macro cell 20A. In this example the deployment strategy is such that the macro layer (macro cells 20A, 20B) is used mainly for coverage and ensuring good mobility while the small cell 22 is used for data offloading purposes (when possible). Illustrated in FIG. 2 are also several independent UEs 10, designated UE1, UE2, UE3 and UE4. These UEs are assumed for the purpose of describing this Figure to be mobile and to be generally moving from left to right in the Figure.

Assume that UE1 is moving across the area in connected mode but without having connected mode DRX configured, and without having buffered UL data. In this case the UE1 would perform continuous measurements and would normally trigger measurement reporting when the neighbor cell (e.g. both the small cell 22 and the macro cell 20B) becomes ‘better’ (e.g. according to the current measurement configuration) than the current serving cell (20A). That is, in accordance with current behavior the UE1 could trigger three measurement reports and potentially could trigger a change of cells three times.

In accordance with the embodiments of this invention the UE1 would not send any measurement reports when passing the small cell 22 as there is no data transmission needed (e.g., the UL data buffer 10G is empty or has less than some threshold amount of buffered data). This eliminates two measurement reporting operations and two handovers. Note that only macro cell 20 mobility is actually needed in this non-limiting example, and not a HO for data offloading purposes.

Assume now that the UE2 has an active data transmission ongoing when passing the area covered by the small cell 22. Therefore the UE2 would, according to the embodiments of this invention, trigger data offloading measurement reporting thereby enabling the eNB 12 to possibly perform HO of the UE2 to the small cell 22, thereby realizing the full offloading benefit for both the network and the UE2.

Assume that the UE3 has active data transmission occurring prior to entering the coverage area of the small cell 22, and further assume that the active data transmission terminates before entering the actual coverage area of the small cell 22. In this case no data offloading reporting is sent from UE3. On the other hand the UE3 could trigger normal mobility HO reporting when crossing the border between macro cell 20A and macro cell 20B.

Assume now further that the UE4 has active data ongoing throughout the entire coverage area. In this case the UE4 may send an offloading report (enabling the benefits of the offloading opportunity from the small cell 22) and a mobility report thereby ensuring robust mobility between the macro cells 20A, 20B and also continuous connectivity and data flow.

From this description of the non-limiting examples presented in FIG. 2 is can seen that the method optimizes the resources concerning cell change signaling both at the UE 10 and at the network, while still ensuring the best use of offloading opportunities, when this is possible, and the need for mobility signaling when this is needed.

In accordance with an aspect of this invention the UE 10 is enabled to send measurement reports based on the condition that the UE 10 has active ongoing data transmissions or has data buffered for transmission. For example, due to ongoing transmission some measurement reports are sent to the network, while the same measurement reports are omitted (i.e., not transmitted to network) if the UE 10 does not have an active data transmission (or data buffered for transmission).

The ability of the UE 10 to distinguish between small (offloading) cells 22 and large (coverage) cells 20 can be realized in different ways. Various non-limiting alternatives for distinguishing between cell types can be, for example, the transmitted power in the cell, a closed subscriber group (CSG) cell indication received by the UE 10, and/or explicit information about the cell type/size.

What follows is an example of the use of the embodiments of this invention in the non-limiting context of E-UTRAN. Note that the embodiments are not limited for use only with E-UTRAN and can be used as well in other types of systems and networks.

Assume that the UE 10 is configured by the E-UTRAN Network to provide the following behavior: measurement reports are not always triggered for the purpose of measurement report sending to the Network 1 at a time when a Time-To-Trigger (TTT) timer expires at the UE 10.

In a first alternative configuration the Network 1 may configure an (existing) event to be sent only if data transmission is ongoing (data transmission could be either UL and/or DL) if radio level triggers are fulfilled. If the UE 10 has a data transfer ongoing, and such an event is triggered, the UE 10 will send the report to the Network. Alternatively, a new event may be specified such that the event is triggered only when the UE 10 has data to offload.

In a second alternative configuration the UE 10 adds to the measurement report the status of UE data transmissions (e.g., status of the UL buffer 10G) if configured for the triggered event.

In a third alternative, when the UE 10 sends a measurement report the Network 1 may check the current buffer status of the UE 10 (UL data) or the eNB 12 (for DL data) and perform a HO to the small cell 22 if offloading is necessary.

Note that it is also possible that a HO to the small cell 22 may occur just for mobility purposes (e.g., coverage purposes).

Note also that the foregoing three alternatives are not exhaustive of the various potential types of operations, and these alternatives are not mutually exclusive.

The various configurations for such behavior may be based to some degree on current E-UTRAN measurement reporting techniques (e.g., as described in the above-referenced 3GPP TS 36.304 and 3GPP TS 36.331), although other options are also possible (such as providing/defining separate, dedicated measurement/measurement reporting/HO configurations).

The UE 10 reporting may be via RRC signaling (e.g., by re-use of currently defined or similar to the currently defined measurement reporting format(s)). The UE 10 reporting may be via a newly defined format (i.e., a new measurement reporting format designed specifically for this purpose).

The second and third alternatives enable the functionality that the NW 1 can determine not to handover the UE 10 to a small cell 22 if there is no data to be transmitted. This method eliminates unnecessary handovers while the UE 10 would still send all measurement reports. The second and third alternatives are straight forward to introduce into specification(s), e.g., LIE-A specifications, as they can be realized with relatively small changes being needed for adding the necessary information (as indicated above) into the measurement report.

The first alternative offers additional benefits in the form of allowing a reduction in the amount of measurement reports sent by the UE 10 by enabling the measurement reports to be eliminated for certain indicated cells/carriers when UE 10 does not have an active data transmission ongoing. If offloading is performed using another carrier or another radio access technology (RAT) the method may be realized by indicating that the inter-frequency/RAT reporting should only occur under the conditions discussed above with respect to the first embodiment (presence of additional considerations) and fourth embodiment (UE 10 knowledge of background traffic mode). If offloading is also done using intra-frequency small cells 22 this could be accomplished by the Network 1 configuring in which cells not to trigger normal (as defined) measurement reporting, but instead apply only the methods of this invention. Such a configuration could be performed by, for example, listing the physical cell identity (PCI) of concerned cells.

It should be noted that an event triggered for mobility/coverage purposes may be handled as currently specified. That is, the exemplary embodiments of this invention can be viewed as operating orthogonally to existing mobility-related measurement reporting rules (without impacting the mobility-related procedures).

The examples of the embodiments of this invention can be used for intra-frequency, inter-frequency and inter-RAT types of handovers and measurement reporting scenarios, and can be applied in both UE 10 idle mode and UE 10 connected mode operations.

While the exemplary embodiments have been described thus far primarily in the context of measurements and measurement reporting related to small cell data offloading scenarios, it should be appreciated that the exemplary embodiments can be used in other scenarios as well. For example, certain exemplary embodiments of this invention can be used for intra-frequency, inter-frequency and inter-RAT types of carrier aggregation and measurement reporting scenarios related to carrier aggregation.

Carrier aggregation (CA) is a technique to provide a wider bandwidth. In the non-limiting case of LTE-A, bandwidth extension may be achieved through aggregating up to five component carriers, each up to 20 MHz wide, to achieve up to a 100 MHz wide spectrum allocation. The carrier aggregation could be contiguous or non-contiguous, that is, the component carriers may be adjacent to each other, or non-adjacent to each other. This technique, as a bandwidth extension, can provide significant gains in terms of peak data rate and cell throughput. FIG. 5 shows a non-limiting example of LTE-A carrier aggregation with five overlapping component carriers, each with an LIE Rel-8 bandwidth of 20 MHz.

In accordance with the embodiments of this invention, when applied to the carrier aggregation scenario the UE 10 can selectively, when operating in a component carrier, and based on at least one criterion at least one of perform measuring or not perform measuring of a component carrier other than the component carrier in which the UE 10 is currently operating, and can further perform transmitting or not transmitting a measurement report for a measured component carrier to a wireless network.

In the carrier aggregation scenario the at least one criterion may comprise a presence or an absence of data in an uplink data buffer of the user equipment, where the presence or absence of data may be with respect to some threshold amount of data being present in the uplink data buffer; and/or it may comprise a DRX mode of operation of the user equipment, and/or it may comprise whether the user equipment is currently involved in at least one of an active uplink data transmission and an active downlink data reception; and/or it may comprise an amount of time that has expired since a last use of a data radio bearer by the user equipment.

In the carrier aggregation scenario the carrier aggregation may be one or more of intra-frequency, inter-frequency and inter-RAT types of carrier aggregation.

This type of operation can thus also be used by the network to at least control the handing off of the UE 10 from one component carrier or carriers to another component carrier or carriers. Alternatively this type of operation could be by the network to, for example, configure or de-configure another component carrier or activate or de-activate another component carrier.

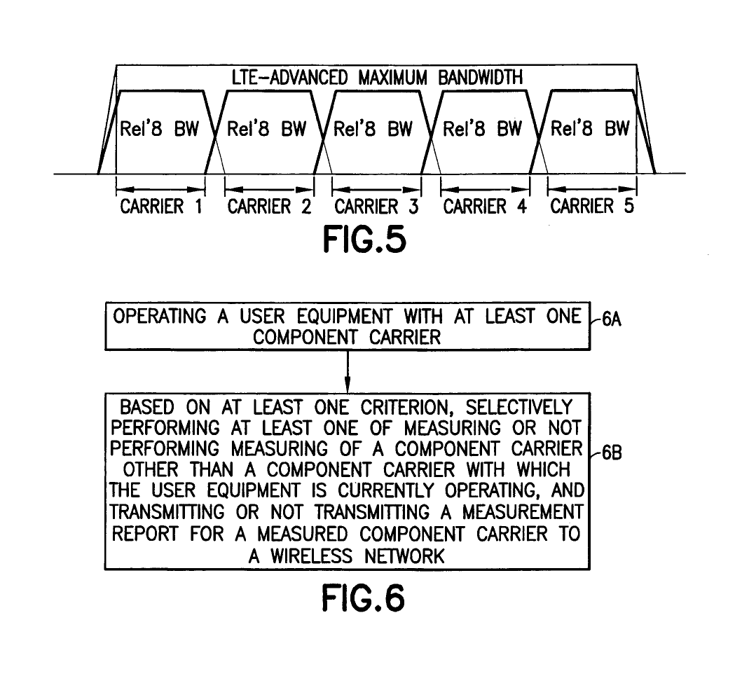

FIG. 6 is a logic flow diagram that illustrates the operation of a method, and a result of execution of computer program instructions embodied on a computer readable medium, further in accordance with the exemplary embodiments of this invention. At Block 6A there is a step of operating a user equipment with at least one component carrier. At Block 6B there is a step performed, based on at least one criterion, of selectively at least one of performing measuring or not performing measuring of a component carrier other than a component carrier with which the user equipment is currently operating, and transmitting or not transmitting a measurement report for a measured component carrier to a wireless network.

There are a number of advantages and technical effects that are made possible by the use of the examples of the embodiments of this invention. For example, the use of these embodiments makes it possible to use the small cells 22 only for offloading purposes, i.e., not for mobility. Further by example, the use of these embodiments can reduce or eliminate unneeded handovers to small cells when a data transfer is not ongoing and mobility is not otherwise needed e.g. due to coverage reasons. Further by example, the use of these embodiments can reduce or eliminate unnecessary reporting, thereby making a more efficient use of network signaling bandwidth and reducing overall network signaling. Further by example, the use of these embodiments may provide more robust mobility procedures. Further by example, the use of these embodiments has been shown to be applicable also to carrier aggregation scenarios, such as those deployed for LTE-A types of networks.

Based on the foregoing it should be apparent that the exemplary embodiments of this invention provide a method, apparatus and computer program(s) to enhance UE 10 and Network 1 operation in a HetNet environment, as well as in a CA environment. Note that operation in the HetNet environment and in the CA environment are not mutually exclusive, and that both types of operation can be simultaneously active.

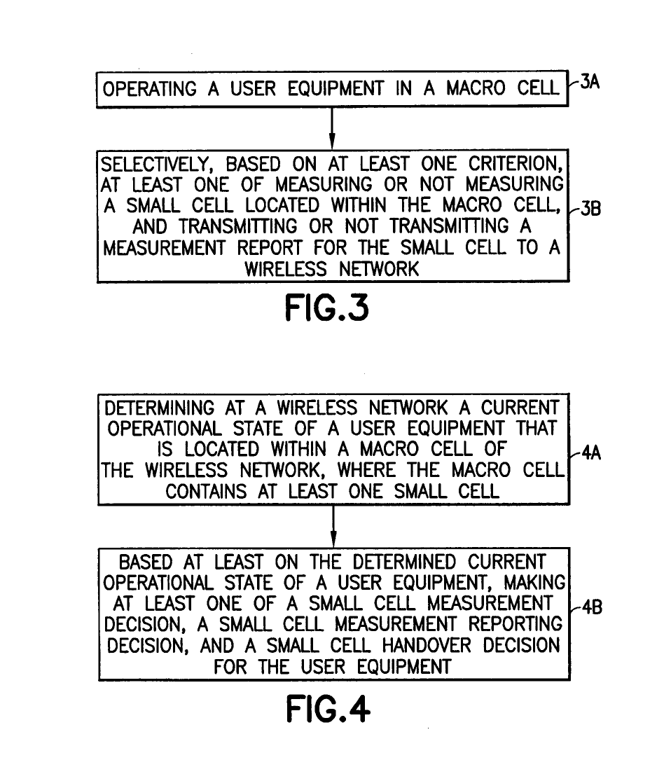

FIG. 3 is a logic flow diagram that illustrates the operation of a method, and a result of execution of computer program instructions, in accordance with the exemplary embodiments of this invention. In accordance with these exemplary embodiments a method performs, at Block 3A, a step of operating a user equipment in a macro cell. At Block 3B there is a step of selectively, based on at least one criterion, at least one of measuring or not measuring a small cell located within the macro cell, and transmitting or not transmitting a measurement report for the small cell to a wireless network.

FIG. 4 is a logic flow diagram that illustrates the operation of a method, and a result of execution of computer program instructions, further in accordance with the exemplary embodiments of this invention. In accordance with these exemplary embodiments a method performs, at Block 4A, a step of determining at a wireless network a current operational state of a user equipment that is located within a macro cell of the wireless network, where the macro cell contains at least one small cell. At Block 4B there is a step performed, based at least on the determined current operational state of the user equipment, of making at least one of a small cell measurement decision, a small cell measurement reporting decision, and a small cell handover decision for the user equipment.

The various blocks shown in FIGS. 3 and 4 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (LTE-A) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters, reports and the like (e.g., BSR, DRB, etc.) are not intended to be limiting in any respect, as these various parameters and reports may be identified by any suitable names. Further, the various names assigned to different network types and components (e.g., E-UTRAN, CA, HetNet, small cell, pico cell, RRH, etc.) are not intended to be limiting in any respect, as these various network types and components may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-56. (canceled)

57. A method, comprising:
operating a user equipment in a macro cell; and
selectively, based on at least one criterion, at least one of measuring or not measuring a small cell located within the macro cell, and transmitting or not transmitting a measurement report for the small cell to a wireless network.

58. The method of claim 57, where the at least one criterion comprises a presence or an absence of data in an uplink data buffer of the user equipment, where the presence or the absence of data is with respect to a threshold amount of data being present in the uplink data buffer.

59. The method of claim 57, where the at least one criterion comprises a discontinuous reception (DRX) mode of operation of the user equipment.

60. The method of claim 57, where the at least one criterion comprises whether the user equipment is currently involved in at least one of an active uplink data transmission and an active downlink data reception.

61. The method of claim 57, where the at least one criterion comprises an amount of time that has expired since a last use of a data radio bearer by the user equipment.

62. The method of claim 57, where for a case that the measurement report is transmitted to the wireless network further comprising including additional information in the measurement report that is related to at least a potential need of the user equipment to perform a data offloading operation to the small cell.

63. The method of claim 57, where the at least one criterion is one of established by the user equipment or is established by the wireless network.

64. An apparatus, comprising:
at least one data processor; and
at least one memory including computer program code, where the at least one memory and computer program code are configured, with the at least one data processor, to cause the apparatus, when the apparatus is operated in a macro cell of a wireless network, to selectively, based on at least one criterion, at least one of measure or not measure a small cell located within the macro cell, and transmit or not transmit a measurement report for the small cell to the wireless network.

65. The apparatus of claim 64, where the at least one criterion comprises a presence or an absence of data in an uplink data buffer of the apparatus, where the presence or the absence of data is with respect to a threshold amount of data being present in the uplink data buffer.

66. The apparatus of claim 64, where the at least one criterion comprises a discontinuous reception (DRX) mode of operation of the apparatus.

67. The apparatus of claim 64, where the at least one criterion comprises whether the apparatus is currently involved in at least one of an active uplink data transmission and an active downlink data reception.

68. The apparatus of claim 64, where the at least one criterion comprises an amount of time that has expired since a last use of a data radio bearer by the apparatus.

69. The apparatus as in claim 64, where for a case that the measurement report is transmitted to the wireless network the at least one memory and computer program code are further configured, with the at least one data processor, to include additional information in the measurement report that is related to at least a potential need of the apparatus to perform a data offloading operation to the small cell.

70. The apparatus as in claim 64, where the at least one criterion is one of established by the apparatus or is established by the wireless network.

71. An apparatus, comprising:
at least one data processor; and
at least one memory including computer program code, where the at least one memory and computer program code are configured, with the at least one data processor, to cause the apparatus to determine at a wireless network a current operational state of a user equipment that is located within a macro cell of the wireless network, where the macro cell contains at least one small cell and, based at least on the determined current operational state of the user equipment, to make at least one of a small cell measurement decision, a small cell measurement reporting decision, and a small cell handover decision for the user equipment.

72. The apparatus as in claim 71, where the current operational state is based at least in part on whether there is buffered data for the user equipment.

73. The apparatus as in claim 71, where the current operational state is based at least in part on a buffer status report that is received from the user equipment.

74. The apparatus as in claim 71, where the current operational state is based at least in part on a discontinuous reception (DRX) mode of operation of the user equipment.

75. The apparatus as in claim 71, where the current operational state is based at least in part on whether the user equipment is currently involved in at least one of an active uplink data transmission and an active downlink data reception.

76. The apparatus as in claim 71, where the current operational state is based at least in part on an amount of time that has expired since a last use of a data radio bearer by the user equipment.
